(19) United States
(12) Patent Application Publication
(10) Pub. No.: US 2006/0175970 A1
(43) Pub. Date: Aug. 10, 2006

(54) Display panel

(76) Inventors: Tim Dekker, Eindhoven (NL); Gerrit Oversluizen, Eindhoven (NL); Siebe Tjerk De Zwart, Eindhoven (NL); Sybrandus Van Heusden, Eindhoven (NL); Roy Van Dijk, Eindhoven (NL); Bart Andre Salters, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/508,286

(22) PCT Filed: Mar. 5, 2003
(86) PCT No.: PCT/IB03/00880

§ 371 Date: Aug. 3, 2005

(30) Foreign Application Priority Data
Mar. 21, 2002 (EP) 02076111.0

(51) Int. Cl. H01J 17/49

(52) U.S. Cl. 313/586; 313/582

(57) ABSTRACT

A flat panel display apparatus comprises plasma discharge cells, which formed between a first base plate (2a) and a second base plate (1a). The first base plate (2a) has pairs of sustain electrodes (2b, 2c), and a second base plate (1a) has data electrodes (1b). Between said electrodes (2b, 2c, 1b) discharge volumes are formed. The device further has a drive circuit which comprises a circuit for providing data to the discharge cells. The display device comprises a conductive layer (51, 72, 91, 101) on the first (2a) or second substrate (1a) for both of a pair of sustain electrodes (2b, 2c). Said conductive layer (51, 72, 91, 101) extends outside the discharge volume (4) and forms an internal capacitance (Cpar) in the display device which capacitance is in parallel to the capacitance formed in operation by the pair of sustain electrodes and the discharge.

### FIELD OF THE INVENTION

The invention relates to a flat panel display device comprising plasma discharge cells, formed between a first base plate, having pairs of sustain electrodes, and a second base plate having data electrodes between which electrodes discharge volumes are formed.

The invention applies particularly to AC plasma display panels (PDPs) used for personal computers, television sets, etc.

### BACKGROUND OF THE INVENTION

In a PDP, each row of the matrix is defined by two electrodes: a scan electrode and a sustain electrode. A cell is defined by one row (two electrodes) and a column electrode.

To show a picture on such a display, a sequence of three driving modes is applied for each sub-frame:

An erase mode, in which old data in the cells is ‘erased’, so the next (sub)frame can be loaded.

An addressing mode, in which the data of the (sub)frame to be shown is written into the cells.

A sustain mode, in which light (and thus the picture) is generated. All cells are sustained at the same time.

These data is often written in subfields to generate grey levels

There exists a need to increase the luminance of the display, and also to increase the luminous efficacy (i.e. the ratio between energy supplied to a pixel and the light output).

### SUMMARY OF THE INVENTION

The invention has as an object to increase the luminance and/or luminance efficacy of a PDP display device.

To this end the PDP display device in accordance with the invention is characterised in that the display device comprises a conductive layer on the first or second substrate for both of a pair of sustain electrodes, said conductive layer forming a capacitance with each of said pair of sustain electrodes, said layer extending outside the discharge volume thereby forming a capacitance internal in the display device and in parallel to the capacitance formed in operation by the pair of sustain electrodes and the discharge.

The inventors have found that providing a conductive layer forming a buffer capacitance for the sustain electrodes greatly increases the luminance. The layer is formed outside the discharge volume since extension of said layer inside the discharge volume tends to have an equalizing effect in voltage over the discharge volume which hampers the discharge leading to a decrease in luminance, rather than an increase. The conductive layer spanning the pair of sustain electrodes (i.e. extending over and between the pair) forms a buffer capacitance in parallel to the capacitance formed by the pair of sustain electrode and the discharge during discharge. Due to this buffer capacitance the discharge is more bright leading to an increase in luminance and efficacy.

Preferably the conductive layer is formed on the first base plate. The electrode may be formed on the second base plate (for instance and in such case preferably on top of barrier ribs). However the amount of capacitive coupling between the conductive layer(s) and the pair of sustain electrodes is best controllable when the conductive layer is provided on the first base plate, i.e. the base plate whereupon the pair of sustain electrodes are provided.

The invention may be embodied in several designs.

In an embodiment a conduction layer is provided on the first plate, wherein the conductive layer is separated from the sustain electrodes by a dielectric layer, the conductive layer being provided at a side of the sustain electrodes opposite to the side of the sustain electrodes facing the discharge volume.

In this embodiment a stack is provided as follows:

Support plate, conductive layer, dielectric layer, pair of sustain electrode, separating layers(s), discharge volume. The conductive layer therefore is formed outside the discharge volume being electrically separated from said discharge volume by the sustaining electrode. The conductive layer extends preferably substantially over a substantial part of the support plate and is transparent. This allows for easy manufacturing, yet clear view of the discharges. Such layers can for instance be made of ITO or ATO. This forms a very simple design and furthermore in such design the overall covering conductive layer forms a capacitive buffer for sustain and scan electrodes alike. It is possible to make such a layer of non-transparent material, but in such cases it need to be restricted to non-light-emitting areas, such as running parallel to the barrier ribs and/or between the pixels. In the latter case manufacturing is more complicated, however, the non-transparent layer would act as a kind of black matrix, improving the contrast.

In a further type of embodiments a dielectric layer is provided on the pair of sustain electrodes at the side facing the discharge volumes and at said dielectric layer a conductive layer is provided extending outside the discharge volume. The discharge volume is formed at and near the gap between a sustain electrodes there where an addressing electrode crosses the sustain electrodes. The conductive layers extend outside the discharge volumes, for instance in parallel to and along the barrier ribs (thus transverse to the longitudinal direction of the sustain electrodes) or parallel to the sustain electrodes but in between the discharge volumes.

In preferred embodiments of the invention each pixel comprises a conductive layer surrounding the discharge volume of a pixel. This embodiments provides the greatest increase in luminance.

In embodiments in which per row of pixels an elongated conductive layer is provided parallel to the row of pixels without having cross-connections between the elongated conductive layers at each pixel but having a cross connection layer at the edge of the display by which the elongated conductive layers are interconnected. The increase in luminance is slightly less, but manufacturing is simpler.

It is advantageous if a flat panel display device according to the invention further comprises a drive circuit providing data to the discharge cells according to a duplicated subfield scheme, the scheme applying different gray level realizations to adjacent groups of cells. As there is generally a good correlation of the gray levels of neighboring cells, the cells in an adjacent group will in most cases have a different gray level realization, when a duplicated subfield scheme is applied alternately to neighboring groups of cells. In case a group comprises cells of a different color, then the correlation will at least be present for two cells of a same color in two adjacent groups. As a result, a cell that has to be driven during a subfield, likely has a neighboring cell, which remains turned off during that subfield. In that case the capacitance of the neighboring cell supports the discharge of the cell that is driven during that subfield, thereby allowing a reduction of the buffer capacitance. A smaller buffer capacitance reduces the capacitive load of the drivers, which means that the power consumption of the display device is lowered.

These and other objects of the invention are apparent from and will be elucidated with reference to the embodiments described hereinafter.

### BRIEF DESCRIPTION OF THE DRAWINGS

In the drawings:

FIG. 1 is a cross-sectional view of a pixel of a PDP device

FIG. 2 schematically illustrates a circuit for driving a PDP of a surface-discharge type in a sub-field mode as known from the prior-art.

FIG. 3 illustrates voltage waveforms between scan electrodes and sustain electrodes of the known PDP.

FIG. 4 further illustrates the layout of pixels in a plasma display panel

FIGS. 5A and 5B illustrate a discharge cell of the prior art

FIGS. 6A and 6B illustrates a discharge cell for or in a display device in accordance with the invention,

FIGS. 7A and 7B illustrates a further example of a discharge cell for or in a display device in accordance with the invention,

FIGS. 8A and 8B illustrate a discharge cell of the prior art

FIGS. 9A and 9B illustrates a discharge cell for or in a display device in accordance with the invention,

FIGS. 10A and 10B illustrates a further example of a discharge cell for or in a display device in accordance with the invention,

FIGS. 11A and 11B illustrate in graphical form the advantageous effects of the invention vis-à-vis prior art.

The Figures are schematic and not drawn on scale. Generally, identical components are denoted by the same reference numerals in the Figures. In some figures reference numerals are not shown for reasons of clarity.

### DETAILED DESCRIPTION OF PREFERRED EMBODIMENTS

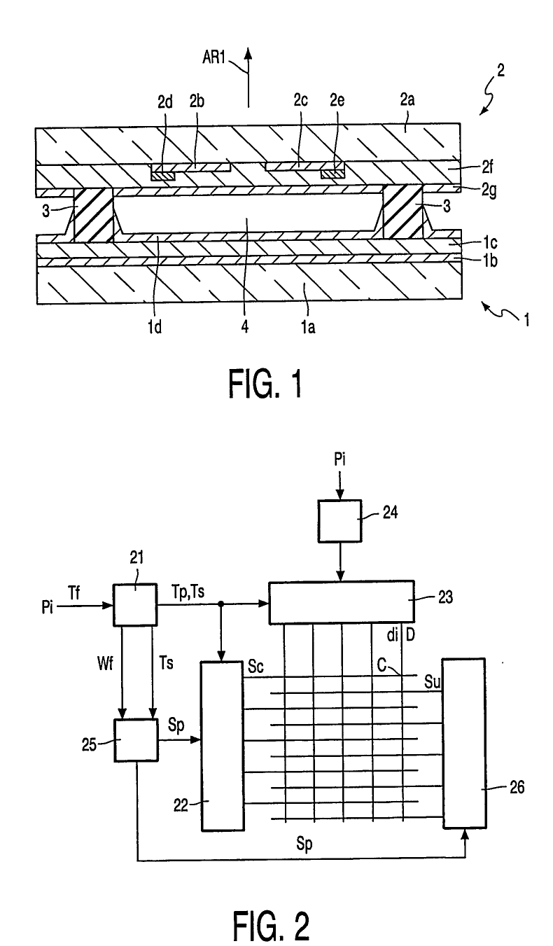

The prior-art pixel shown in FIGS. 1 and 2 produces an image in the following steps.

FIG. 1 illustrates the structure of a pixel (discharge cell). The pixel comprises a back substrate structure 1 and a front structure 2, and a partition wall 3 which spaces the back structure 1 from the front structure 2. This partition wall (often in the form of barrier ribs) is in this drawing shown as being provided parallel to the scan and sustain electrodes. Such designs do exist where every pixel is formed in a little box of partition walls. However, often only barrier ribs are provided running parallel and in between sets of scan and sustain electrodes. Discharge gas such as helium, neon, xenon or a gaseous mixture thereof fills the space between the back structure 1 and the front structure 2. A discharge 4 takes in operation place in the discharge cell. The discharge gas generates ultra-violet light during discharging. The back structure 1 includes a transparent glass plate 1 a and a data electrode 1b is formed on the transparent glass plate 1a. The data electrode 1b is covered with a dielectric layer 1c, and a phosphor layer 1d is laminated on the dielectric layer 1c. The ultra-violet light is radiated onto the phosphor layer 1d, and the phosphor layer 1d converts the ultra-violet light into visible light. The visible light is indicated by arrow AR1. The front substrate 2 includes a transparent glass plate 2a, and a scan electrode 2b and a sustain electrode 2c are formed on the transparent glass plate 2a. The scan electrode 2b and the sustain electrode 2c extend perpendicularly to the data electrode 1b. Bus electrodes 2d/2e may be laminated on the scan electrode 2b and the sustain electrode 2c, respectively, and are expected to reduce the resistance against a scanning signal and a sustain signal. These electrodes 2b, 2c, 2d and 2e are covered with a dielectric layer 2f, and the dielectric layer 2f may be covered by a protective layer 2g. The protective layer 2g is for instance formed of magnesium oxide and protects the dielectric layer 2f from the discharge. An initial potential larger than the discharging threshold is applied between a scan electrode 2b and a data electrode 1b. Discharging takes place between them. Positive charge and negative charge are attracted towards the dielectric layers 2f/1c over the scan electrode 2b and the data electrode 1b and are accumulated thereon as wall charges. The wall charges produce potential barriers and gradually decrease the effective potential. Therefore, the discharge is stopped after some time. Thereafter, a sustain pulse is applied between the scan electrodes 2b and the sustain electrodes 2c which pulse is identical in polarity to the wall potential. During the sustain period scan and sustain electrodes work in pairs, thus forming in effect pairs of sustain electrodes. The wall potential is superimposed on the sustain pulse. Because of the superimposition the effective potential exceeds the discharging threshold and a discharge is initiated. Thus, while the sustain pulse is being applied between the pairs of sustain electrodes 2b, 2c, the sustain discharge is initiated and continued. This is the memory function of the device. This process occurs in all pixels at the same time. During such sustain phase the scan and sustain electrode therefore act in cooperation, which is the reason that in some publications, when discussing effects during the sustain phase, both types of electrodes 2b and 2c are called ‘sustain electrodes’ as is done within the framework of the present invention.

When an erase pulse is applied between the scan electrodes 2b and the sustain electrodes 2c, the wall potential is cancelled, and the sustain discharge is stopped.

FIG. 2 schematically illustrates a circuit for driving a PDP of a surface-discharge type in a sub-field mode as known from the prior art. Two glass panels (not shown) are arranged opposite to each other. Data electrodes D are arranged on one of the glass panels. Pairs of scan electrodes Sc and sustain electrodes Su are arranged on the other glass panel. The scan electrodes Sc are aligned with the sustain electrodes Su, and the pairs of scan and sustain electrodes Sc, Su are perpendicular with respect to the data electrodes D. Display elements (for example, plasma cells or pixels C) are formed at the crosspoints of the data electrodes and the pairs of scan and sustain electrodes Sc, Su. A timing generator 21 receives display information Pi to be displayed on the PDP. The timing generator 21 divides a field period Tf of the display information Pi into a predetermined number of consecutive sub-field periods Tsf. A sub-field period Tsf comprises an address period or prime period Tp and a display or sustain period Ts. During an address period Tp, a scan driver 22 supplies pulses to the scan electrodes Sc, and a data driver 23 supplies data di to the data electrodes D to write the data di to the display elements C associated with the selected scan electrode Sc. In this way the display elements C associated with the selected scan electrode Sc are preconditioned. A sustain driver 26 drives the sustain electrodes Su. During an address period Tp, the sustain driver 26 supplies a fixed potential. During a display period Ts, a sustain pulse generator 25 generates sustain pulses Sp which are supplied to the display elements C via the scan driver 22 and the sustain driver 26. The display elements, which are preconditioned during the address period Tp to produce light during the display period Ts, produce an amount of light depending on a number or a frequency of sustain pulses Sp. It is also possible to supply the sustain pulses Sp to either the scan driver 22 or the sustain driver 26.

The timing generator 21 further associates a fixed order of weight factors Wf with the sub-field periods Sf in every field period Tf. The sustain generator 25 is coupled to the timing generator to supply a number or a frequency of sustain pulses Sp in conformance with the weight factors Wf such that an amount of light generated by the preconditioned display element C corresponds to the weight factor Wf. A sub-field data generator 24 performs an operation on the display information Pi such that the data di is in conformance with the weight factors Wf.

When regarding a complete panel, the sustain electrodes Su are often interconnected for all rows of the PDP panel. The scan electrodes Sc are connected to row ICs and scanned during the addressing or priming phase. The column electrodes D are operated by column Ics and the plasma cells C are operated in three modes:

1. Erase mode. Before each sub-field is primed, all plasma cells C are erased at the same time. This is done by first driving the plasma cells C into a conducting state and then removing all charge built up in the cells C.

2. Prime mode. Plasma cells C are conditioned such that they will be in an on or off state during the sustain mode. Since a plasma cell C can only be fully on or off, several prime phases are required to write all bits of a luminance value. Plasma cells C are selected on a row-at-a-time basis and the voltage levels on the columns Co will determine the on/off condition of the cells. If a luminance value is represented in 9 bits, then also 9 sub-fields are defined within a field. Different examples of sub-field distributions are possible.

3. Sustain mode. An alternating voltage is applied to scan and sustain electrodes Sc, Su of all rows at the same time. The column voltage is mainly at a constant potential. The plasma cells or pixels C primed to be in the on state, will light up. The weight of an individual luminance bit will determine the number of light pulses during sustain. During the sustain periods the scan and sustain electrodes form pairs of sustain electrodes.

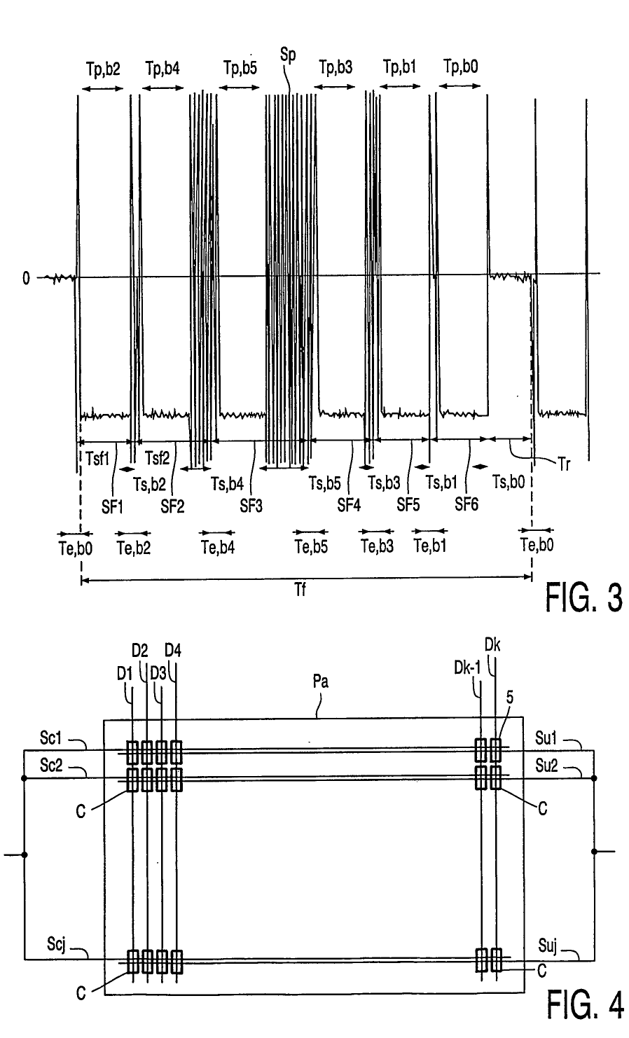

FIG. 3 shows voltage waveforms between scan electrodes Sc and sustain electrodes Su of a PDP. Since there are three modes, the corresponding time sequence is indicated as Te,bx (erase mode for bit-x sub-field), Tp,bx (prime mode for bit-x subfield) and Ts,bx (sustain mode for bit-x subfield). The different subfields are indicated by SF1, SF2 etc. In this example there are six subfields (SF1 to SF6) within the field Tf. The subfield distribution is 4/16/32/8/2/1

FIG. 4 further illustrates the layout of pixels C in a plasma display panel Pa. The pixels are identical in structure to the pixel shown in FIG. 1 and form a display area. The pixels are arranged in j rows and k columns, and a small box stands for each pixel in FIG. 4. Scan electrodes (Sci) and sustain electrodes (Sui) extend in the direction of the rows, and the scan electrodes are paired with the sustain electrodes respectively. The pairs of sustain electrodes are associated with the rows of pixels respectively Data electrodes (Di) extend in the direction of columns, and are associated with the columns of pixels, respectively.

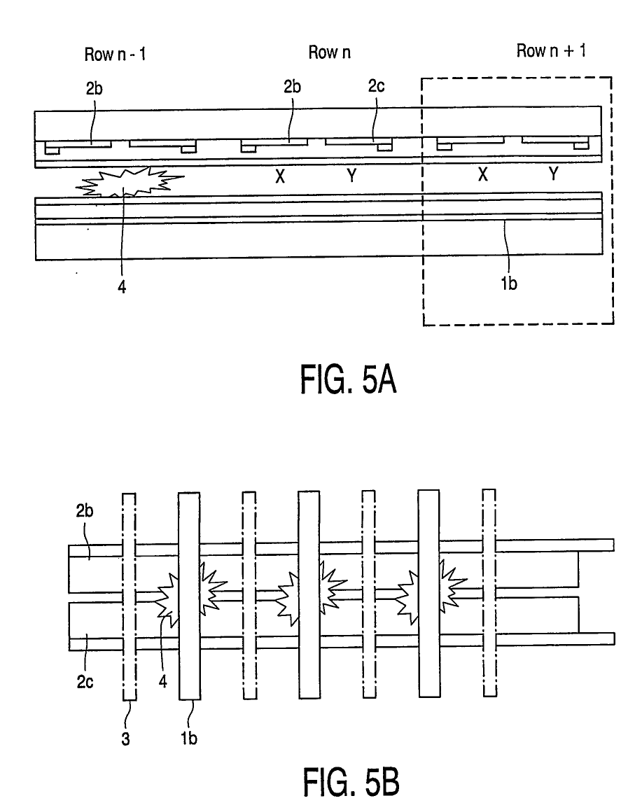

FIGS. 5A and 5B illustrate a discharge cell of the prior art. FIG. 5A shows a view transversal to the base plates, similar to FIG. 1, FIG. 5B shows a bottom view, roughly corresponding to the dotted area in FIG. 5A. In between pairs of sustain electrodes 2b, 2c and the data electrode 1b a discharge 4 is formed.

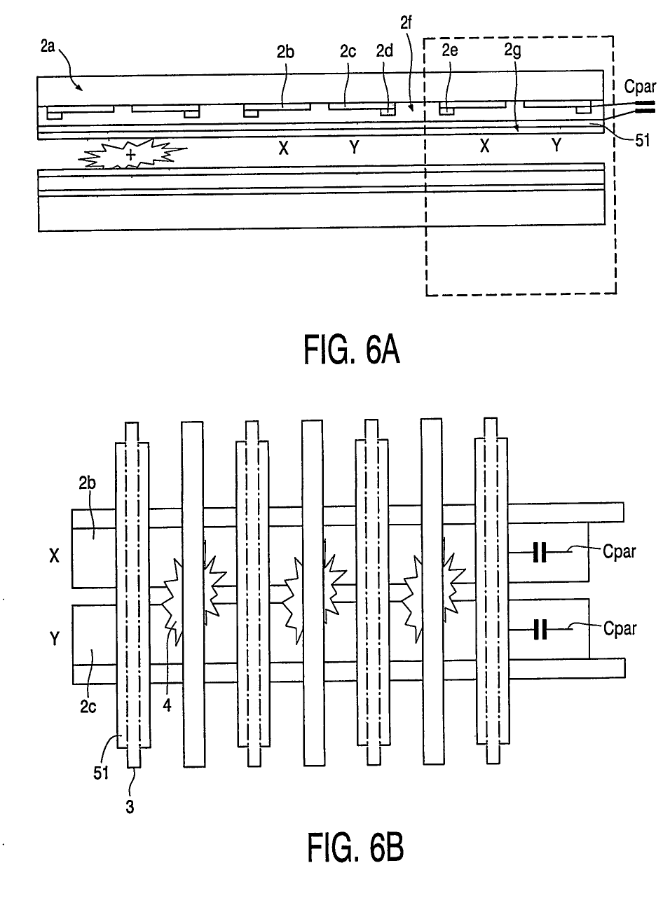

FIGS. 6A and 6B illustrates a discharge cell for or in a display device in accordance with the invention.

Starting from the plate 2a, the following stack is made (without being restricted in the sense that no other layer could be present in the stack): Plate 2a-electrodes 2c,2b, electrodes 2d, e, layer 2f, conductive layer 51, layer 2g, discharge 4 (in operation). Conducting layers 51 are thus provided at the sides of the sustain electrodes 2b, 2c facing the discharges 4, and and said layers are separated from said electrodes 2b, 2c by a dielectric layer as can be seen in FIG. 6A. As can be seen in FIG. 6B the layers 51 span the electrodes 2b, 2c (i.e. extends over both of them) and form capacitances Cₚₐᵣ with both of them. In FIG. 6A for clarity only one of the capacitances is shown, in FIG. 6B both are schematically indicated. The pairs of sustain electrodes are here denoted X and Y. During discharge a capacitance is formed between layers 51 and electrodes 2b, 2c forming a capacitance internal in the display and parallel to the capacitance formed between the sustain electrodes 2b, 2c and the discharge. Without wanting to be restricted to any particular theoretical explanation of the beneficial effect of the provision of the conductive layers it is assumed that during discharge the parallel capacitance ‘feeds’ the discharge, thereby increasing the luminance. It is of importance to note that the conductive layers 51 substantially do not extend in those areas of the display where the discharges 4 are formed. This can be seen in FIG. 6B where the layers 51 extend in areas outside the discharges 4 (the stars in FIG. 6B). Extensions of the conductive layers 51 over the areas at which discharges are formed in operation would tend to equalize the voltage over the wall at the discharge area which would decrease or hamper the discharge, leading to a reduction of efficacy.

The circuit for driving the PDP as shown in FIG. 2 may be adapted to include a duplicated subfield scheme (DSF-scheme). DSF-schemes are known in the art and will not be elaborated in detail here. When applying a DSF-scheme which uses different gray level realizations for adjacent cells and assuming that there is a good correlation between the data di supplied to these adjacent cells C, then in many cases adjacent cells C will be activated during different subfields. As a result when a particular cell C is activated during a subfield, the adjacent cells are not activated.

So, during discharge of an activated cell the parallel capacitance Cₚₐᵣ of the adjacent cells can be used fully to feed the discharge of the activated cell. As a consequence the parallel capacitance Cₚₐᵣ may be chosen smaller, when applying a DSF-scheme. A smaller parallel capacitance Cₚₐᵣ has the advantage that the driver circuits have a lower capacitive load, which results in a lower power consumption.

In a color PDP, a group of adjacent cells may comprise cells for generating a red, green and a blue color, respectively. As the correlation of the gray levels to be realized for adjacent cells of a different color is low, it is in this case more appropriate to apply the DSF-scheme to such groups of cells.

As there is a good correlation of the gray levels of two cells of a same color present in two adjacent groups, these two cells will, in most cases, have a different gray level realization. So, the parallel capacitance Cₚₐᵣ of one of the two cells of the same color can be used to support the discharge of the other one of the two cells.

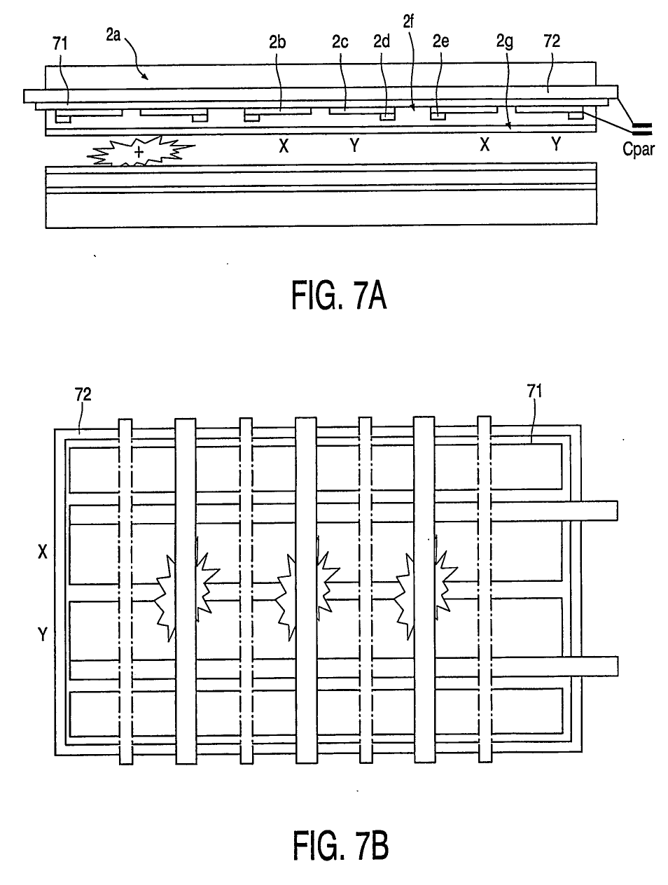

FIGS. 7A and 7B illustrates a further example of a discharge cell for or in a display device in accordance with the invention. FIG. 7A showing a transversal view, FIG. 7B a bottom view.

Starting from the plate 2a, the following stack is made (without being restricted in the sense that no other layer could be present in the stack): Plate 2a-conductive layer(s) 72-dielectric layer 71, electrodes 2c,2b, electrodes 2d, e, layer 2f, layer 2g, discharge 4 (in operation). In this example a dielectric layer 71 is thus provided at the sides of the electrodes 2b, 2c opposite to the discharge 4, i.e. the electrodes are arranged inbetween the conductive layer(s) 71 and the discharges (4). On said dielectric layer a conductive layer 72 is provided. A capacitance Cₚₐᵣ is formed between this conductive layer 72 and each of the sustain electrodes 2b, 2c (only one of which capacitances is shown in FIG. 7A). In this case, since layer 72 extends at the side of the electrodes 2b, 2c opposite to the discharges 4, the layer may extends over the full area. The ‘voltage smoothing effect’ or the effect of forming a capacitance in series is much less of a problem.

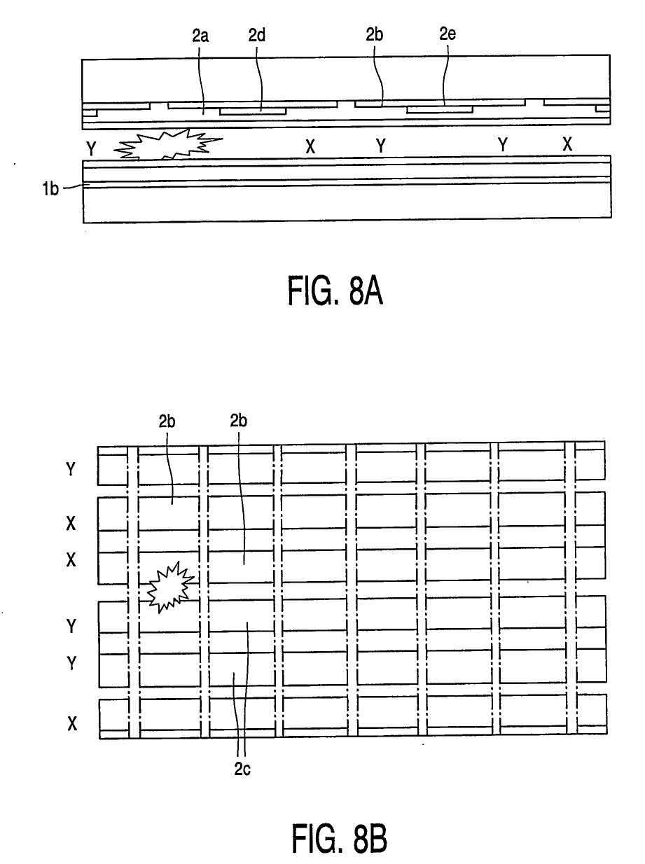

FIGS. 8A and 8B illustrate a discharge cell of the prior art. In this example the pattern of the sustain electrodes 2b, 2c is slightly different, instead of a sequences of sustain electrodes X-Y-X-Y-X-Y as in FIG. 5A the sequence is X-Y-Y-X-X-Y-Y etc. For more information on this type of lay-out of the sustain electrodes reference is made to for instance: SID 99 Digest Pages 154-157: High-Resolution Interlaced Addressing for Plasma Displays by Kanazawa et al.

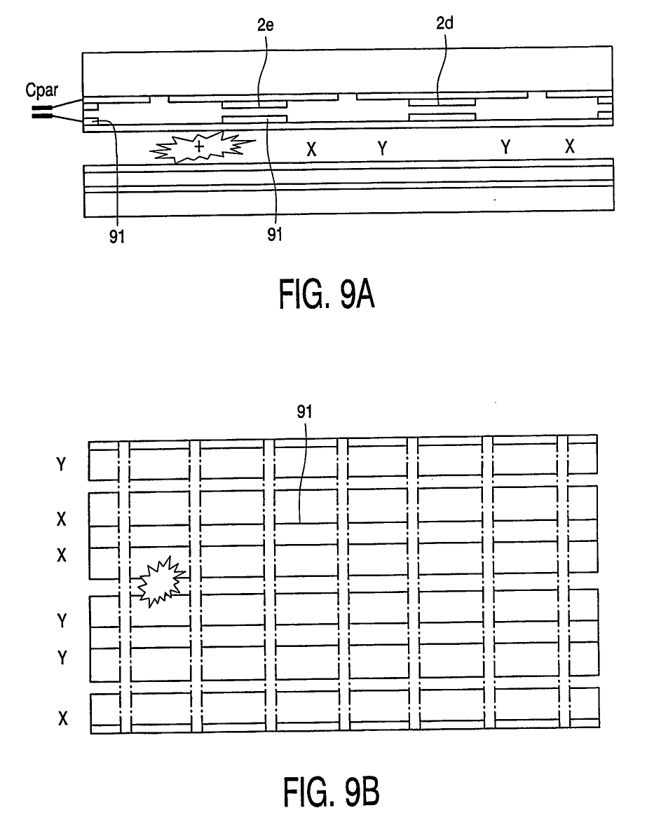

FIGS. 9A and 9B illustrates a discharge cell for or in a display device in accordance with the invention. A conductive layer 91 is provided which runs parallel to the row, under electrodes 2e and 2d. These electrodes 91 are (not shown here) connected outside the display area. Again there are capacitance formed between the electrodes 2b and 2d and the conductive layers 91, forming a capacitance parallel to the capacitance formed by the sustain electrode 2b, 2c and the discharge during discharge.

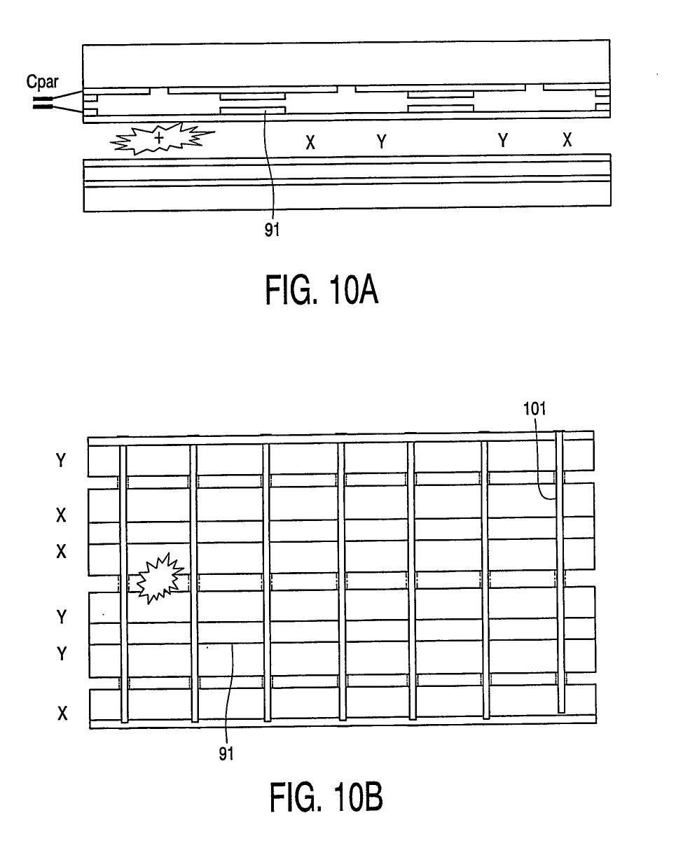

FIGS. 10A and 10B illustrates a further example of a discharge cell for or in a display device in accordance with the invention. In this example the conductive layers 91 are interconnected by the layers 101 (this could be seen as a combination of the design of FIG. 9A and the design of FIG. 6A). In this exemplary embodiment each pixel is surrounded by a conductive layer.

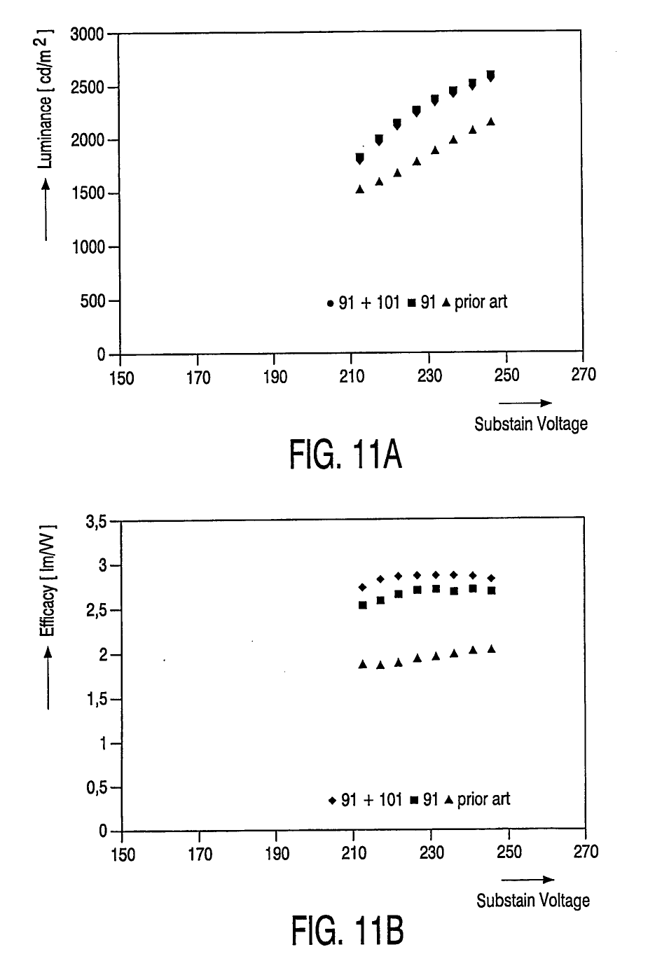

FIGS. 11A and 11B illustrate in graphical form the advantageous effects of the invention vis-à-vis prior art. FIG. 11A shows the luminance as a function of sustain voltage, FIG. 11B shows the efficacy as a function of sustain voltage. The triangles are measurement made on known devices as schematically illustrated in FIGS. 8A and 8B, the squares stand for a device is which longitudinal conductive layers 91 are provided, so that capacitance is provided per row, the diamonds for a device in which layers 91 and 101 are provided, so that capacitance is provided per pixel. The figures show a very substantial increase in luminance and efficacy of roughly 25-40%, also showing (see FIG. 11B) that provision of layers 91 and 101 is an improvement over provision of layers 91 only.

The internal capacitance Cₚₐᵣ is formed by the conductive layers and the sustain electrodes in parallel to the capacitance formed between the sustain electrodes and the discharge. During discharge this capacitance acts as a buffer capacitance increasing the luminance. As far as the value of this buffer capacitance is concerned, it is preferred that said value is of the order of the capacitance formed between the sustain electrodes and the discharge (N.B. the value of this capacitance is the capacitance during discharge), preferably between 4 times and ¼^{th}, most preferably between 2 and ½th of said value.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

In short the display device in accordance with the invention can be described as follows:

A flat panel display apparatus comprises plasma discharge cells, which formed between a first base plate (2a) and a second base plate (1a). The first base plate (2a) has pairs of sustain electrodes (2b, 2c), and a second base plate (1a) has data electrodes (1b). Between said electrodes (2b, 2c, 1b) discharge volumes are formed. The device further has a drive circuit which comprises a circuit for providing data to the discharge cells. The display device comprises a conductive layer (51, 72, 91, 101) on the first (2a) or second substrate (1a) for both of a pair of sustain electrodes (2b, 2c). Said conductive layer (51, 72, 91, 101) extends outside the discharge volume (4) and forms an internal capacitance (Cₚₐᵣ) in the display device which capacitance is in parallel to the capacitance formed in operation by the pair of sustain electrodes and the discharge.

1. Flat panel display device comprising plasma discharge cells, formed between a first base plate (2a), having pairs of sustain electrodes (2b, 2c), and a second base plate (1a) having data electrodes (1b) between which electrodes discharge volumes are formed, a conductive layer (51; 72, 91, 101) being present on the first (2a) or second base plate (1a) for both of a pair of sustain electrodes (2b, 2c), said conductive layer (51; 72, 91, 101) forming a capacitance (Cₚₐᵣ) with each of said pair of sustain electrodes (2b, 2c), said layer (51; 72, 91, 101) extending outside the discharge volume thereby forming the capacitance (Cₚₐᵣ) internal in the display device and in parallel to a capacitance formed in operation by the pair of sustain electrodes (2b, 2c) and a discharge (4).

2. Flat panel display device as claimed in claim 1, wherein the conductive layer (51; 72, 91, 101) is formed on the first base plate (2a).

3. Flat panel display device as claimed in claim 2, wherein the conductive layer (72) is separated from the sustain electrodes (2b, 2c) by a dielectric layer (71), the conductive layer (72) being provided at a side of the sustain electrodes (2b, 2c) opposite to the side of the sustain electrodes (2b, 2c) facing the discharge volume.

4. Flat panel display device as claimed in claim 2, wherein a dielectric layer (2f) is provided on the pair of sustain electrodes (2b, 2c) at the side facing the discharge volume and at said dielectric layer a conductive layer (51) is provided extending outside the discharge volume.

5. Flat panel display device as claimed in claim 1, wherein each pixel comprises a conductive layer (91, 101) surrounding the discharge volume of a pixel.

6. Flat panel display device as claimed in claim 1, wherein per row of pixels an elongated conductive layer (91) is provided parallel to the row of pixels without cross-connections between the elongated conductive layers (91) per pixel but having a cross connection layer at an edge of the display by which connection layer the elongated conductive layers are (91) electrically interconnected.

7. Flat panel display device as claimed in claim 1, wherein the conductive layer (51; 72; 91, 100) is formed on the second base plate.

8. Flat panel display device as claimed in claim 1, further comprising a drive circuit providing data (di) to the discharge cells according to a duplicated subfield scheme, the scheme applying different gray level realizations to adjacent groups of cells.

9. Flat panel display apparatus, comprising a flat panel display device as claimed in claim 1; a drive circuit for receiving display information (Pi) and for deriving data (di) for driving the discharge cells from the display information (Pi); and
means for receiving an image signal and converting the image signal in the display information (Pi).
